(19) United States
(12) Patent Application Publication
(10) Pub. No.: US 2010/0173588 A1
(43) Pub. Date: Jul. 8, 2010

(54) Method and apparatus for suppressing radio frequency interference from bluetooth wireless communication channels

(76) Inventors: Stuart Owen Goldman, Scottsdale, AZ (US); Karl F. Rauscher, Emmaus, PA (US)

Correspondence Address: Alcatel-Lucent USA Inc., Docket Administrator - Room 2F-192, 600 Mountain Avenue, Murray Hill, NJ, 07974-0636, US

(21) Appl. No.: 12/319,239

(22) Filed: Jan. 5, 2009

(51) Int. Cl. H04B 15/00

(52) U.S. Cl. 455/63.1

(57) ABSTRACT

A method and apparatus whereby RF (radio frequency) interference in a Bluetooth wireless communications link is suppressed using an enhancement to the Bluetooth protocol which operates to eliminate noise that is induced on the RF path by external electronic interference. The sampling rate at a Bluetooth transmitter is doubled, and samples are transmitted alternately with and without audio data (e.g., the microphone input data for a Bluetooth headset in transmit mode, or the speaker output data for a Bluetooth mobile phone in transmit mode) included therein. At the Bluetooth receiver, received samples which have been transmitted without audio data are subtracted from (i.e., inverted and digitally added to) corresponding ones of the received samples which have been transmitted with audio data, and the receiver then advantageously uses (only) the (modified) samples resultant therefrom, thereby removing the interference from the signal without reducing the effective sampling rate.

### FIELD OF THE INVENTION

The present invention relates generally to the field of Bluetooth wireless communications, and more particularly to a method and apparatus for suppressing RF (radio frequency) interference that occurs when a Bluetooth wireless communications link is used in close proximity to a device which generates interfering RF noise.

### BACKGROUND OF THE INVENTION

The use of the Bluetooth wireless protocol has become extremely ubiquitous. One of the most common uses of Bluetooth is for providing wireless headset capability, such as, for example, those used to connect (wirelessly) to a mobile (cell) phone in order to provide the mobile phone user with fully hands-free operation. One of the common problems experienced with such uses however, is RF (radio frequency) interference that occurs whenever the headset and/or the mobile phone is used in close proximity to a device which generates such interfering RF noise. For example, when a mobile phone which uses a Bluetooth headset is physically located near a laptop or desktop computer, such RF interference is not uncommon. This causes noise to be introduced on the call which is disturbing to the other party (or parties) on the call, as well as to the user of the Bluetooth headset him- or herself. Similar interference problems may result from the use of a Bluetooth wireless device in close proximity to any other RF noise-generating apparatus, such as automobile engines, appliances, generators, etc.

Although there are noise cancellation schemes which cancel audio noise in the vicinity of the user, these schemes are of no help to the problem of electronic interference noise in the RF transmission path. Thus, unfortunately, the only solution currently available to a user of a Bluetooth headset and/or mobile phone in close proximity to a computer is to either stop using the headset or to move away from the computer. If the user is also making use of the computer, however, neither solution is acceptable (or at least desirable). Therefore, it would be highly beneficial if a method for suppressing RF (radio frequency) interference that occurs when a Bluetooth wireless communications link is used in close proximity to a device which generates interfering RF noise could be found.

### SUMMARY OF THE INVENTION

We have recognized that RF (radio frequency) interference in a Bluetooth wireless communications link may be advantageously suppressed with use of an enhancement to the Bluetooth protocol which operates to eliminate noise that is not in the audio environment but that is induced on the RF path itself by external electronic interference. In particular, in accordance with an illustrative embodiment of the present invention, the sampling rate at a Bluetooth transmitter is doubled, and samples are transmitted alternately with and without the audio data (e.g., the microphone input data for a Bluetooth headset in transmit mode, or the speaker output data for a Bluetooth-enabled mobile phone in Bluetooth transmit mode) included therein. Then, at the Bluetooth receiver, the received samples which have been transmitted without the audio data therein are subtracted from (i.e., inverted and digitally added to) corresponding (i.e., adjacent) ones of the received samples which have been transmitted with the audio data, and the receiver then advantageously uses (only) the modified samples which result from this calculation as the actual audio data. This technique thereby advantageously removes the RF interference from the signal without reducing the effective sampling rate.

Note that since the sampling rate is high compared to the frequency of the first derivative of the noise (i.e., the change in the noise), the subtraction of these adjacent samples will advantageously result in an excellent representation of the pure audio signal with substantially reduced interference noise. That is, since a received sample which has been transmitted without the audio data included therein likely contains the same noise component as the corresponding (i.e., adjacent) received sample which has been transmitted with the audio data included therein, such a subtraction of these alternating samples (i.e., subtracting those without the audio data from those with the audio data) will advantageously result in an audio signal with reduced RF interference. In particular, this technique will thereby effectively remove any noise component with duration greater than twice the sampling frequency.

More specifically, in accordance with one illustrative embodiment of the present invention, a method and apparatus is provided for wirelessly transmitting audio data across a wireless link so as to enable a receiver to reduce Radio Frequency (RF) interference present in said wireless link, the wireless link being used to transmit a sequence of audio data samples each comprising a portion of said audio data, the method or apparatus comprising: transmitting a first sample comprising one of said audio data samples in said sequence; and transmitting a second sample, in close temporal proximity to said transmission of said first sample, wherein said second sample does not comprise any of said audio data.

In addition, in accordance with another illustrative embodiment of the present invention, a method and apparatus is provided for reducing Radio Frequency (RF) interference from audio data received at a wireless receiver from a wireless link, the wireless link being used to transmit a sequence of audio data samples each comprising a portion of said audio data, the method or apparatus comprising: receiving a first sample comprising one of said audio data samples in said sequence; receiving a second sample, in close temporal proximity to said receipt of said first sample, wherein said second sample does not comprise any of said audio data; and modifying said received first sample comprising said audio data sample based on said received second sample, such that a portion of said Radio Frequency (RF) interference is reduced.

### BRIEF DESCRIPTION OF THE DRAWINGS

FIG. 1 shows an illustrative environment in which a Bluetooth wireless communications link, which is experiencing RF (radio frequency) interference from a nearby laptop computer, may be advantageously enhanced in order to suppress such RF interference in accordance with an illustrative embodiment of the present invention.

FIG. 2 shows a flowchart of an illustrative process to be performed by a Bluetooth wireless transmitter such as, for example, a Bluetooth headset, to enable the suppression of RF interference at a corresponding receiver in accordance with an illustrative embodiment of the present invention.

FIG. 3 shows a flowchart of an illustrative process to be performed by a Bluetooth wireless receiver which receives a signal transmitted by the Bluetooth wireless transmitter of FIG. 2, for the suppression of RF interference in accordance with an illustrative embodiment of the present invention.

### DETAILED DESCRIPTION OF THE PREFERRED EMBODIMENTS

As explained above, in accordance with an illustrative embodiment of the present invention, the sampling rate at a Bluetooth transmitter is advantageously doubled, and samples are advantageously transmitted alternately with and without the audio data (e.g., the microphone input data for a Bluetooth headset in transmit mode, or the speaker output data for a Bluetooth-enabled mobile phone in Bluetooth transmit mode) included therein. Then, at the Bluetooth receiver, the received samples which have been transmitted without the audio data therein are advantageously subtracted from (i.e., inverted and digitally added to) corresponding (i.e., adjacent) ones of the received samples which have been transmitted with the audio data, thereby removing the RF interference from the signal without reducing the effective sampling rate.

In accordance with one illustrative embodiment of the present invention, a flag is advantageously sent along with each sample to indicate whether the given sample comprises one which has been transmitted with the audio data included therein or one which has been transmitted without the audio data included therein. In this manner, the receiver can easily identify which samples have the audio data and which do not. In accordance with other illustrative embodiments of the present invention, other approaches, easily derived by those of ordinary skill in the art, may be employed to identify which samples have the audio data and which do not.

In accordance with one such illustrative embodiment of the present invention (which uses another approach to identify which samples have the audio data and which do not), for example, an initial flag indicating whether the first sample to be sent thereafter does or does not have the audio data, followed by a strict alternation of such samples, will enable the receiver to easily keep track of which samples are which. And, in accordance with yet another such illustrative embodiment of the present invention (which uses yet another approach to identify which samples have the audio data and which do not), no flags are transmitted along with the alternating samples (i.e., those with audio data and those without), and the receiver advantageously “assumes” that samples having a smaller magnitude (as compared with the preceding or following sample) are, in fact, samples without audio data included, whereas samples having a larger magnitude (as compared with the preceding or following sample) are, in fact, samples with audio data included.

Note that in accordance with various illustrative embodiments of the present invention, these processes may be performed in either one or in both directions of a Bluetooth wireless link. For example, in accordance with one illustrative embodiment of the present invention, the subtraction of alternative samples may be advantageously performed in a Bluetooth-enabled mobile phone but not in a Bluetooth headset (and, therefore, the transmission of alternating samples with and without the audio data included would be advantageously performed only in the headset and not in the mobile phone), since the smaller size and desired cost of the Bluetooth headset may make the inclusion of such functionality slightly more difficult or costly. It is preferable, however, to perform the illustrative processes of the present invention in both directions, in order to fully suppress the RF interference.

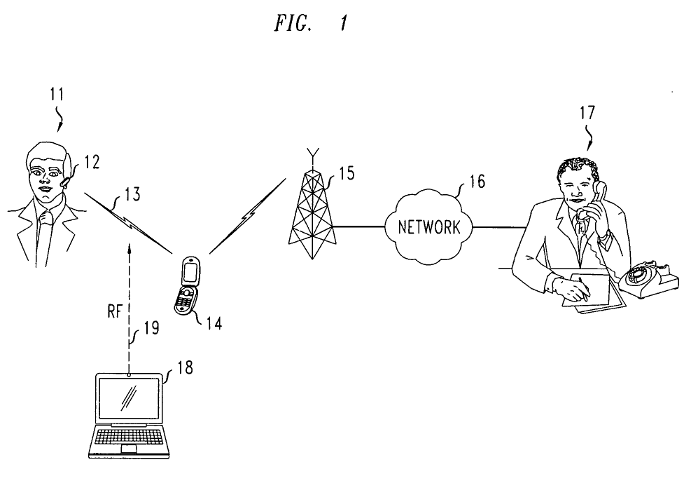

FIG. 1 shows an illustrative environment in which a Bluetooth wireless communications link, which is experiencing RF (radio frequency) interference from a nearby laptop computer, may be advantageously enhanced in order to suppress such RF interference in accordance with an illustrative embodiment of the present invention. The figure shows headset user 11, who is engaged in a phone conversation with other party 17, using Bluetooth headset 12 to wirelessly connect via Bluetooth link 13 to nearby cell phone 14. Cell phone 14 is, in turn, wirelessly connected to cell tower 15, which is connected via communications network 16 to the other party (i.e., other party 17). However, as can be seen in the figure, laptop 18 is physically located near Bluetooth link 13, and is emitting RF signal 19 which would result in RF interference with Bluetooth link 13 but for the advantageous suppression thereof in accordance with an illustrative embodiment of the present invention.

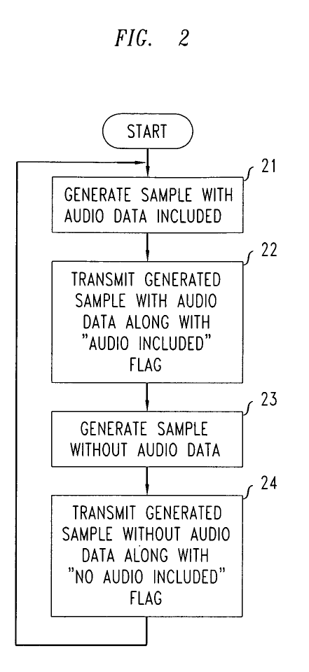

FIG. 2 shows a flowchart of an illustrative process to be performed by a Bluetooth wireless transmitter such as, for example, a Bluetooth headset, to enable the suppression of RF interference at a corresponding receiver in accordance with an illustrative embodiment of the present invention. The illustrative transmission process advantageously alternates between sending a sample which includes the audio data (e.g., the microphone input data of a Bluetooth headset) and sending a sample which does not include the audio data (e.g., with the microphone input of the Bluetooth headset temporarily disabled or disconnected).

Specifically, in block 21 of the illustrative flowchart shown in FIG. 2, a sample is generated with the audio data included (e.g., with the microphone input of the Bluetooth headset enabled), and in block 22 that sample is transmitted, along with a flag indicating that this particular sample includes the audio data. Then, in block 23 of the flowchart, a sample is generated without any audio data (e.g., with the microphone input of the Bluetooth headset disabled), and in block 24 that sample is transmitted, along with a flag indicating that this particular sample does not include any audio data. Flow then returns to block 21, and the illustrative process of FIG. 2 iterates for as long as the Bluetooth connection is active. Advantageously, the sample rate (of the combined sample types—i.e., those with the audio data included and those without) is twice what a “normal” (i.e., prior art) Bluetooth transmission would use, thereby resulting in the same effective sampling rate of the actual audio data.

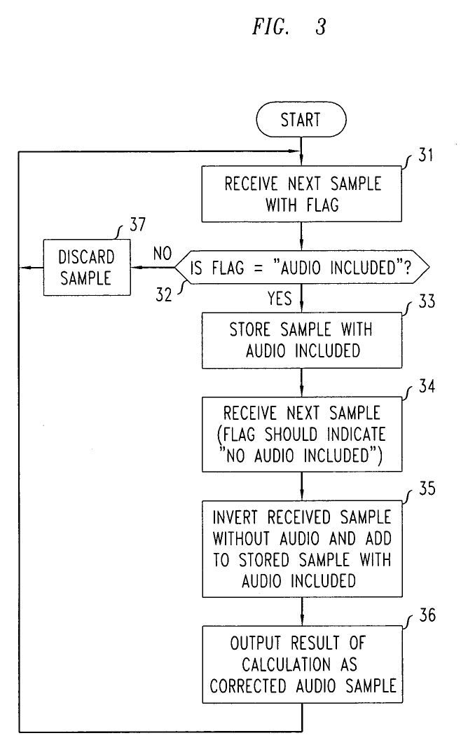

FIG. 3 shows a flowchart of an illustrative process to be performed by a Bluetooth wireless receiver which receives a signal transmitted by the Bluetooth wireless transmitter of FIG. 2, for the suppression of RF interference in accordance with an illustrative embodiment of the present invention. The illustrative process, which may, for example, be performed by a Bluetooth-enabled mobile phone, receives a signal (i.e., a sequence of samples) from a Bluetooth transmitter (e.g., a Bluetooth headset) which advantageously alternates between a sample which includes audio data (e.g., the microphone input data of a Bluetooth headset) and a sample which does not include audio data (e.g., with the microphone input of the Bluetooth headset temporarily disabled or disconnected). Then, the process advantageously subtracts the received samples which do not include the audio data from the corresponding (i.e., adjacent) samples which do include the audio data, and uses (only) the modified samples which result therefrom, thereby generating an audio signal which advantageously suppresses any RF interference.

Specifically, in block 31 of the illustrative flowchart shown in FIG. 3, a sample is received along with a flag indicating whether this sample does or does not include audio data. Then, decision block 32 checks the flag—if it indicates that the first received sample does not include audio data, it discards that sample in block 37 and flow then returns to block 31 to get the next sample. When decision block 32 determines that a sample has been received which does include audio data (which, if the first received sample does not include audio data, should occur when the very next sample is received, based on the alternation of samples with and without audio data as transmitted by the illustrative flowchart of FIG. 2), flow proceeds to block 33 where the given received sample (with audio data) is stored (for later use). Then, flow proceeds to block 34 which receives the next sample, which should be (again, based on the alternation of samples with and without audio data as transmitted by the illustrative flowchart of FIG. 2) one that does not include audio data. (In accordance with one illustrative embodiment of the present invention, this flag may be advantageously verified at the receipt of each sample in order to ensure that a sample has not been lost in transmission. This verification for samples which should not include audio data is not explicitly shown in FIG. 2, but adding this would be trivially obvious to one of ordinary skill in the art.)

Next, in block 35, the sample (without audio data) received in block 34 is inverted and added to (i.e., subtracted from) the stored sample (i.e., the corresponding sample with the audio data) which was previously stored in accordance with block 33. The resultant value is then advantageously output in block 36. This output may, for example, comprise a modified (i.e., corrected) audio sample for use in an audio signal to be transmitted by a mobile phone to another party to the conversation. Finally, flow returns to block 31 to receive the next sample, which should be (again, based on the alternation of samples with and without audio data as transmitted by the illustrative flowchart of FIG. 2) one which does contain audio data, and the illustrative process iterates for as long as the Bluetooth connection is active.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, although the above discussion has focused primarily on Bluetooth-enable mobile (e.g., cellular) phones and Bluetooth headsets, it will be obvious to those of ordinary skill in the art that the principles of the present invention may be equally advantageous and may be easily applied in numerous other contexts in which a wireless link of any type is subject to electronic (e.g., RF) interference from any source whatsoever.

In addition, although the above described embodiments have been limited to those which send (and receive) samples which strictly alternate between those that do have the audio data included therein and those that do not, it will be obvious to those skilled in the art that numerous other arrangements in which some samples are sent without the audio data may be used to accomplish the same result. That is, the fundamental principle of (a) transmitting samples which do not include the audio data, which are (in any way) interspersed with samples that do include the audio data, and (b) at the receiver, using the samples which do not include audio data as a basis with which to reduce or eliminate electronic interference present in the samples which do include the audio data, may be applied in a large variety of situations, and are all intended to be included within the scope of the instant claims herein.

In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for wirelessly transmitting audio data across a wireless link so as to enable a receiver to reduce Radio Frequency (RF) interference present in said wireless link, the wireless link being used to transmit a sequence of audio data samples each comprising a portion of said audio data, the method comprising the steps of:
transmitting a first sample comprising one of said audio data samples in said sequence; and
transmitting a second sample, in close temporal proximity to said transmission of said first sample, wherein said second sample does not comprise any of said audio data.

2. The method of claim 1 wherein said first sample further comprises a flag indicating that said first sample comprises one of said audio data samples in said sequence, and wherein said second sample further comprises a flag indicating that said second sample does not comprise any of said audio data.

3. The method of claim 1 wherein the wireless link comprises a Bluetooth wireless link.

4. The method of claim 3 wherein the method is performed at a Bluetooth headset, and wherein the second sample is generated by temporarily disconnecting microphone input data of the Bluetooth headset.

5. The method of claim 3 wherein the method is performed at a Bluetooth-enabled mobile phone, and wherein the second sample is generated by temporarily disconnecting speaker output data of the Bluetooth-enabled mobile phone.

6. The method of claim 1 wherein the steps of transmitting the first sample and transmitting the second sample are repeated in alternating order.

7. The method of claim 6 wherein the repetitive steps of transmitting the first sample and transmitting the second sample are performed with a total sampling rate equal to twice a sampling rate of said sequence of audio data samples.

8. A method of reducing Radio Frequency (RF) interference from audio data received at a wireless receiver from a wireless link, the wireless link being used to transmit a sequence of audio data samples each comprising a portion of said audio data, the method comprising the steps of:
receiving a first sample comprising one of said audio data samples in said sequence;
receiving a second sample, in close temporal proximity to said receipt of said first sample, wherein said second sample does not comprise any of said audio data; and
modifying said received first sample comprising said audio data sample based on said received second sample, such that a portion of said Radio Frequency (RF) interference is reduced.

9. The method of claim 8 wherein said first sample further comprises a flag indicating that said first sample comprises one of said audio data samples in said sequence, and wherein said second sample further comprises a flag indicating that said second sample does not comprise any of said audio data.

10. The method of claim 8 wherein the wireless link comprises a Bluetooth wireless link.

11. The method of claim 10 wherein the method is performed at a Bluetooth-enabled mobile phone, and wherein the second sample had been generated by temporarily disconnecting microphone input data of a Bluetooth headset wirelessly connected to the Bluetooth-enabled mobile phone.

12. The method of claim 10 wherein the method is performed at a Bluetooth headset and wherein the second sample had been generated by temporarily disconnecting speaker output data of a Bluetooth-enabled mobile phone wirelessly connected to the Bluetooth headset.

13. The method of claim 8 wherein the steps of receiving the first sample, receiving the second sample, and modifying said received first sample are performed and repeated in sequence.

14. The method of claim 13 wherein the repetitive steps of receiving the first sample and receiving the second sample are performed with a total sampling rate equal to twice a sampling rate of said sequence of audio data samples.

15. The method of claim 8 wherein the step of modifying said received first sample comprises subtracting the received second sample from said received first sample to produce said modified received first sample.

16. An apparatus for wirelessly transmitting audio data across a wireless link so as to enable a receiver to reduce Radio Frequency (RF) interference present in said wireless link, the wireless link being used to transmit a sequence of audio data samples each comprising a portion of said audio data, the apparatus comprising a wireless transmitter which:
(a) transmits a first sample comprising one of said audio data samples in said sequence, and
(b) transmits a second sample, in close temporal proximity to said transmission of said first sample, wherein said second sample does not comprise any of said audio data.

17. The apparatus of claim 16 wherein said first sample further comprises a flag indicating that said first sample comprises one of said audio data samples in said sequence, and wherein said second sample further comprises a flag indicating that said second sample does not comprise any of said audio data.

18. The apparatus of claim 16 wherein the wireless link comprises a Bluetooth wireless link.

19. The apparatus of claim 18 wherein the apparatus comprises a Bluetooth headset, and wherein the second sample is generated by temporarily disconnecting microphone input data of the Bluetooth headset.

20. The apparatus of claim 18 wherein the apparatus comprises a Bluetooth-enabled mobile phone, and wherein the second sample is generated by temporarily disconnecting speaker output data of the Bluetooth-enabled mobile phone.

21. The apparatus of claim 16 wherein the transmission of the first sample and the transmission of the second sample are repeated in alternating order.

22. The apparatus of claim 21 wherein the repetition of the transmission of the first sample and the transmission of the second sample are performed with a total sampling rate equal to twice a sampling rate of said sequence of audio data samples.

23. An apparatus for reducing Radio Frequency (RF) interference from audio data received from a wireless link, the wireless link being used to transmit a sequence of audio data samples each comprising a portion of said audio data, the apparatus comprising:
a wireless receiver which
(a) receives a first sample comprising one of said audio data samples in said sequence, and
(b) receives a second sample, in close temporal proximity to said receipt of said first sample, wherein said second sample does not comprise any of said audio data; and
a processor which modifies said received first sample comprising said audio data sample based on said received second sample, such that a portion of said Radio Frequency (RF) interference is reduced.

24. The apparatus of claim 23 wherein said first sample further comprises a flag indicating that said first sample comprises one of said audio data samples in said sequence, and wherein said second sample further comprises a flag indicating that said second sample does not comprise any of said audio data.

25. The apparatus of claim 23 wherein the wireless link comprises a Bluetooth wireless link.

26. The apparatus of claim 25 wherein the apparatus comprises a Bluetooth-enabled mobile phone, and wherein the second sample had been generated by temporarily disconnecting microphone input data of a Bluetooth headset wirelessly connected to the Bluetooth-enabled mobile phone.

27. The apparatus of claim 25 wherein the apparatus comprises a Bluetooth headset, and wherein the second sample had been generated by temporarily disconnecting speaker output data of a Bluetooth-enabled mobile phone wirelessly connected to the Bluetooth headset.

28. The apparatus of claim 23 wherein the receipt of the first sample, the receipt of the second sample, and the modifying of said received first sample are performed and repeated in sequence.

29. The apparatus of claim 28 wherein the receipt of the first sample and the receipt of the second sample are performed with a total sampling rate equal to twice a sampling rate of said sequence of audio data samples.

30. The apparatus of claim 23 wherein the processor modifies said received first sample by subtracting the received second sample from said received first sample to produce said modified received first sample.
